(19) United States
(12) Patent Application Publication
(10) Pub. No.: US 2006/0186609 A1
(43) Pub. Date: Aug. 24, 2006

(54) Drill chuck and hand power tool having drill chuck

(76) Inventors: Otto Baumann, Leinfelden-Echterdingen (DE); Rolf Mueller, Leinfelden-Echterdingen (DE); Thomas Bernhardt, Aichtal-Groetzingen (DE)

Correspondence Address: STRIKER, STRIKER & STENBY, 103 EAST NECK ROAD, HUNTINGTON, NY, 11743, US

(21) Appl. No.: 11/294,899

(22) Filed: Dec. 6, 2005

(30) Foreign Application Priority Data
Feb. 22, 2005 (DE) 10 2005007996.2

(51) Int. Cl. B23B 31/12

(52) U.S. Cl. 279/62

(57) ABSTRACT

A drill chuck for a hand power tool has a chuck body, an adaptor part that is connectable to the chuck body, guide receptacles provided in the chuck body and inclined relative to a chuck axis, clamping jaws guided longitudinally displaceably in the guide receptacles, and a clamping bush which is coaxial with the chuck axis, for adjusting the clamping jaws, and a retaining bush, the chuck body and the adaptor part being united in a one-piece component; and a hand power tool is provided with the drill chuck.

### BACKGROUND OF THE INVENTION

The invention is based on a drill chuck and a hand power tool having a drill chuck.

In hand power tools, such as drill hammers, replaceable drill chucks are known that serve to clamp a tool bit firmly. The replaceable drill chucks are connected either manually, by actuating a bush, or by an automatic locking mechanism to a spindle of the hand power tool, such as a hammer barrel or a drill hammer spindle. This connection is usually made via a cylindrical receptacle in the drill chuck body, into which the spindle is introduced with little play. Locking bodies, such as balls or locking blocks, assure a rotational slaving of the drill chuck that has been slipped on and fix the drill chuck in the axial direction.

Combinations are also known in which the locking body serves only to fix the drill chuck axially on the spindle of the hand power tool, and a form-locking connection for the rotational slaving of the drill chuck is formed by means of toothing or a hexagonal connection.

Standard drill chucks are for instance a toothed ring with a drill chuck wrench. These drill chucks are typically connected to an adapter part in a manner fixed against relative rotation, for instance being screwed onto a thread. To secure the screwed connection between the drill chuck and the adapter part against unintentional loosening in counterclockwise operation, an additional screw with a counterclockwise thread may be provided. The construction is relatively complex because of the combination of the drill chuck and the adapter, and in drilling work in vulnerable materials such as wood or metal, the desired precision guidance of the drill is seldom attained.

An elegant solution to this problem, which also provides more-precise drill guidance, is a fast-change system. In a fast-action drill chuck, clamping can be done without a tool. The known fast-action drill chucks generally have a retaining ring and a clamping bush. The retaining ring is firmly held with one hand as the tool bit, for instance a steel drill, is chucked and released. With the other hand, the clamping bush can be rotated, in order to clamp the tool bit in a tool bit receptacle of the drill chuck for instance with a clockwise rotation and to release it again with a counterclockwise rotation. For clamping and releasing the tool bit, clamping jaws that grip the tool bit may be provided, guided longitudinally displaceably in guide receptacles of the drill chuck body that are inclined to a chuck axis. The clamping jaws transmit the requisite torque to the tool bit by means of form locking.

Single-sleeve drill chucks in hand power tools, especially power drills, are also known in which the drill spindle is equipped with a blocking function. Upon changing tool bits, the spindle is automatically arrested. The single-sleeve drill chuck makes it possible to change the tool bit quickly with one hand and thus makes the power tool very convenient to use. Work operations that require different tool bits are thus done quickly. The relative complex construction of the hand power tool is problematic, however.

### SUMMARY OF THE INVENTION

Accordingly, it is an object of the present invention to provide a drill chuck and a hand power tool having the drill chuck which are further improvements of the drill chucks and the hand power tools.

In a drill chuck of the invention and in a hand power tool having a drill chuck of the invention, the chuck body and the adapter part are united in a one-piece component. The total length of the drill chuck is then advantageously shortened considerably, because a connection typically in the form of a thread between the chuck body and the adapter part can be dispensed with.

Because the thread is omitted, the total length is favorably shortened by more than 10 mm, for instance by 14 mm. This reduces the total weight of the drill chuck and thus of the entire hand power tool, on the one hand, and on the other it lessens the nose-heaviness of the hand power tool, which enhances the ease of use considerably. Another advantage is that the sine-piece drill chuck body of the invention improves the quality of concentricity of the tool bits fastened in it. The hand power tool is thus also suited for more-demanding tasks.

Preferably, the chuck body and the adapter part are embodied in one piece, which favorably increases the stability.

In a preferred embodiment of the drill chuck of the invention, a rotational slaving means is located between a retaining bush, which is provided for adjusting clamping jaws, and the chuck body. Especially preferably, the rotational slaving means is embodied as a claw connection, making an especially stable connection feasible. Expediently, the rotational slaving means engages the retaining bush on its inside radially circumferentially between the clamping jaws.

The clamping jaws may be located in a region of the guide receptacles that is protected from dust, which lengthens the service life of the hand power tool.

### BRIEF DESCRIPTION OF THE DRAWING

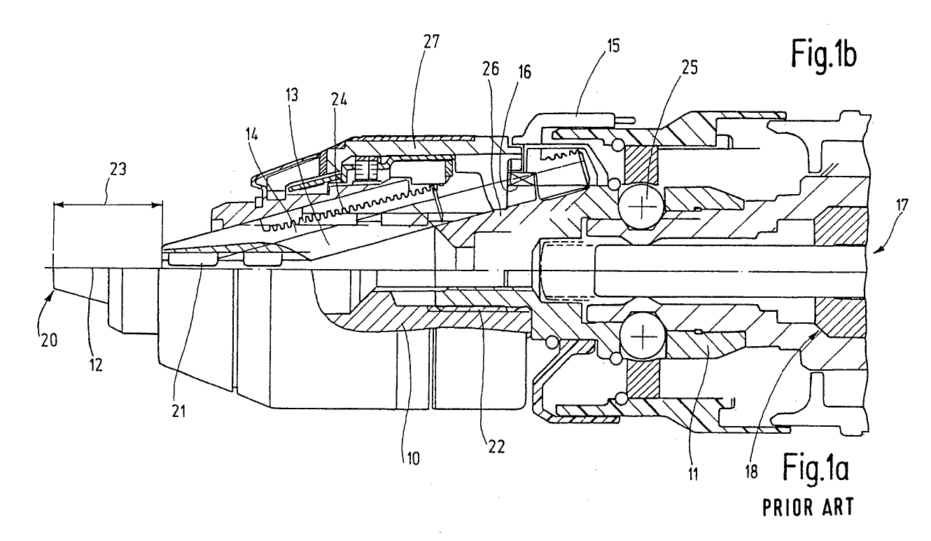

The sole FIGURE of the drawing shows an embodiment known from the prior art in the lower half, FIG. 1a, and an embodiment according to the invention of the drill chuck of the invention in the upper half, FIG. 1b.

### DESCRIPTION OF THE PREFERRED EMBODIMENT

The drawing shows a drill chuck with a chuck body 10 and an adapter part 11 that can be connected to the chuck body 10. In a first axial end 17 of the drill chuck, there is a spindle receptacle 18, as a result of which a connection with a hand power tool is made. A tool bit receptacle 21 is located on a second axial end of the drill chuck. In FIG. 1a, the chuck body 10 and the adapter part 11 are embodied in two parts and are joined together by a threaded connection 22. In FIG. 1b, conversely, the chuck body 10 and the adapter part 11 are united in a one-piece component 26.

The component 26 is preferably embodied in one piece, and as a result the total length of the drill chuck of the invention is shortened considerably, specifically by a length 23 that is equivalent to the length of the now dispensed-with thread 22. As a result, a shorter structural length and a lower total weight of the drill chuck of the invention are advantageously attained, so that the nose-heaviness of the power tool can also be reduced.

The tool bit, not shown in the drawing, is introduced into the tool bit receptacle 21 and chucked between a total of for instance three clamping jaws 14, of which only one clamping jaw 14 can be seen in the drawing. In the drawing, a three-jaw chuck is shown. However, two-jaw chucks are also possible. The clamping jaws 14 are guided longitudinally displaceably in the guide receptacles 13, and the guide receptacles 13 are embodied as inclined in the chuck body 10 relative to a chuck axis 12. The clamping jaws 14 are located in a region of guide receptacles 13 that is protected against dust. The clamping jaws 14 have a radially outer row 24 of teeth that is engaged by an adjusting thread.

For adjusting the clamping jaws 14, a clamping bush 27 is provided that is coaxial with the chuck axis 12. Between a retaining bush 15 and the chuck body 10, there is a rotational slaving means 16. The rotational slaving means 16 is designed according to the invention as a claw connection; for the sake of clearer illustration, it is shown rotated by 60° in the drawing. The rotational slaving means 16 engages the retaining bush 15 on the inside radially circumferentially between the clamping jaws 14.

When the clamping bush 27 is rotated and tightened, a torque acting in the closing direction is exerted relative to the chuck axis 12 of the chuck body 10, and as a result, the clamping jaws 14 are longitudinally displaced inside the guide receptacles 13 in the direction of the second axial end 20 of the chuck body 10 and fix the tool bit. Upon a rotation of the clamping bush 27 counter to the closing direction, the tool bit is released again.

A locking device 25 is designed in particular as balls on the chuck body 10 and forms a form lock with the spindle receptacle 18.

It will be understood that each of the elements described above, or two or more together, may also find a useful application in other types of constructions differing from the types described above.

While the invention has been illustrated and described as embodied in a drill chuck and hand power tool having a drill chuck, it is not intended to be limited to the details shown, since various modifications and structural changes may be made without departing in any way from the spirit of the present invention.

Without further analysis, the foregoing will reveal fully reveal the gist of the present invention that others can, by applying current knowledge, readily adapt it for various applications without omitting features that, from the standpoint of prior art, fairly constitute essential characteristics of the generic or specific aspects of the invention.

What is claimed as new and desired to be protected by Letters Patent is set forth in the appended claims:

1. A drill chuck for a hand power tool, comprising a chuck body; an adaptor part that is connectable to said chuck body; guide receptacles provided in said chuck body and inclined relative to a chuck axis; clamping jaws guided longitudinally displaceably in said guide receptacles; a clamping bush which is coaxial with the chuck axis, for adjusting said clamping jaws; and a retaining bush, said chuck body and said adaptor part being united in a one-piece component.

2. A drill chuck as defined in claim 1, wherein said chuck body and said adaptor part are formed in one piece with one another.

3. A drill chuck as defined in claim 1; and further comprising rotational slaving means located between said retaining bush and said chuck body.

4. A drill chuck as defined in claim 3, wherein said rotational slaving means is configured as a claw connection.

5. A drill chuck as defined in claim 3, wherein said rotational slaving means engage said retaining bush on an inside radially circumferentially between said clamping jaws.

6. A drill chuck as defined in claim 1, wherein said clamping jaws are located in a region of said guide receptacles that is protected form the dust.

7. A hand power tool as defined in claim 1, wherein the drill chuck is configured for a hand power tool selected from the group consisting of a drill hammer, a chisel hammer and both, and is drivable to provide an action selected from the group consisting of hammering, rotating, and both.

8. A hand power tool, comprising a drill chuck including a chuck body and an adaptor part connectable to said chuck body, said chuck body and said adaptor part being united in one-piece component.

9. A hand power tool as defined in claim 7, wherein the hand power tool is a tool selected from the tool consisting of a drill hammer, a chisel hammer, and both and is drivable to provide an action selected from the group consisting of hammering, rotating, and both.
